(19) United States
(12) Patent Application Publication
(10) Pub. No.: US 2003/0175478 A1
(43) Pub. Date: Sep. 18, 2003

(54) Plasterboard and its manufacture

(76) Inventor: Claude Leclercq, Pernes Les Fontaines (FR)

Correspondence Address: BURNS, DOANE, SWECKER & MATHIS, L.L.P., P.O. Box 1404, Alexandria, VA, 22313-1404, US

(21) Appl. No.: 10/345,289

(22) Filed: Jan. 16, 2003

Related U.S. Application Data
(63) Continuation of application No. PCT/FR01/02268, filed on Jul. 12, 2001.

(30) Foreign Application Priority Data
Jul. 18, 2000 (FR) 00 09 395

(51) Int. Cl. B32B 5/12

(52) U.S. Cl. 428/105; 428/113

(57) ABSTRACT

A plasterboard having a plaster-based core, wherein the plasterboard is provided on at least one of its sides with a glass-fiber mat facing, the mat facing being coated on an external face with a coating composition including a mineral filler, with the exception of hydratable calcium sulphates; and an organic or mineral binder.

### CROSS-REFERENCE TO RELATED APPLICATIONS

The present application is a continuation of PCT Application No. PCT/FR01/02268, filed on Jul. 12, 2001, which claims priority of Application No. 00 09395, filed in France on Jul. 18, 2000. The entire contents of both applications is incorporated herein by reference.

### BACKGROUND OF THE APPLICATION

The present invention relates to a plasterboard, notably having greatly improved fire resistance and to a process for manufacturing this plasterboard.

It is well known to use plasterboards for producing partitions, coverings for vertical or inclined elements or for producing ceilings, whether suspended or not.

These boards generally consist of an essentially plaster core covered on each of its sides with a sheet which serves both as reinforcement and as facing and which may be made of paperboard or a mat of mineral fibers.

European Patent Application No. 0 470 914 of the Applicant disclosed in 1992 a plasterboard intended for fire protection, the faces of which are covered with a reinforcing material based on mineral and/or refractory yarns and/or fibers.

The subject-matter of U.S. Pat. No. 4,647,496 is an exterior insulation system for a building, comprising a plaster support surface provided with a glass mat and an adhesive having an internal surface which adheres to an insulating material essentially devoid of channels passing through it, and an external surface on which an exterior finishing material is placed. The plaster support surface may be a plasterboard having a plaster core coated on both its sides with a porous glass mat.

European Patent Application No. EP-A-755 903 relates to a construction board having a high fire resistance, both sides of which are covered with a glass-fiber web, which board consists of a hydraulic setting mix of an α-semihydrate containing from 0.2 to 0.5% by weight of a retarder and an alum, in a weight ratio of from 75/25 to 40/60. The glass-fiber webs may be coated on their external faces with a thin precoating consisting of a mix essentially composed of β-calcium sulphate semihydrate or anhydrite and small amounts of an organic binder. This precoating allows the process to be carried out easily and satisfactorily in the usual plants for producing paperboard-faced plasterboards. Furthermore, it seals off the glass-fiber webs so that no material containing alum can go from the core of the board to the external face of the glass-fiber web.

### OBJECTS AND SUMMARY

The Applicant has continued its research in the field of plasterboards for the purpose, in particular, of reducing the liberation of glass fibers during the use of boards with a glass-fiber mat facing and to improve the appearance of the surface of the boards, their paintability, their fire reaction performance and their fire resistance performance.

It has now achieved its objectives by developing a plasterboard with improved fire resistance, having a plaster-based core and being characterized in that the said board is provided on at least one of its sides with a facing consisting of a glass-fiber mat, this mat being coated on its external face with a coating composition comprising:

a mineral filler, with the exception of hydratable calcium sulphates; and

an organic or mineral binder.

The second subject of the invention is a glass-fiber mat coated with a coating composition comprising:

a mineral filler, with the exception of hydratable calcium sulphates;

an organic or mineral binder; and

a water-repellent agent.

Finally, the third subject of the invention is a process for manufacturing a plasterboard comprising at least one coated glass-fiber mat as just described.

The plasterboards according to the invention thus have a better surface finish that that of the plasterboards of the prior art.

Thus, the colouring uniformity of the facing of the board and the absence of veining on the visible side of the board may be immediately noted.

In addition, the gross calorific value of the boards according to the invention is generally markedly less than that of the boards of the prior art.

Furthermore, the temperature at which the board's facing melts or is destroyed is pushed up from 700° C. (according to the prior art) to 1000° C. (according to the invention).

Moreover, the glass fibers of the mats do not become detached as they are well bonded.

Finally, the painting behaviour is satisfactory; practically no change in colour between the board and the joint is detectable and painting requires no special preparation of the support.

### DETAILED DESCRIPTION OF THE PREFERRED EMBODIMENTS

Further characteristics and advantages of the invention will now be described in detail in the description which follows.

Plasterboard

The term “plaster” should be understood to mean, in the present description, the product resulting from the hydraulic setting and the hardening of a hydratable calcium sulphate, that is to say an anhydrous calcium sulphate (anhydrite II or III) or a semihydrated calcium sulphate (CaSO₄.½H₂O) in its α or β crystalline form. These compounds are well known to those skilled in the art and are generally obtained by baking a gypsum.

The plaster core generally comprises mineral and/or refractory fibers which are preferably glass fibers. They may be short (3 to 6 mm on average) or quite long (10 to 24 mm on average) or of intermediate lengths.

In particular, fibers made from an E-type glass are used, these possibly being in two forms, one form being called a “roving” and comprising glass strands supplied on reels and cut before they are introduced into the usual circuit for mixing the hydratable calcium sulphate with water, or else in the form of precut strands which are metered before mixing the hydratable calcium sulphate with water.

Fibers having a length of 13 mm and a diameter of 13 microns are preferably used.

The essential function of the glass fibers is to impart high-temperature mechanical strength, thereby allowing the calcined plaster to maintain its cohesion.

The core of the plasterboard may also include a mix of mineral additives for the purpose of improving the dimensional stability and the thermal performance of the plasterboard.

The core of the plasterboard may also include a mix of additives aimed at improving the water resistance; hydrophobic and/or water-repellent additives are appropriate. Mention may be made of those indicated in Patent U.S. Pat. No. 5,220,762, namely organohydrogeno-polysiloxanes.

Glass-fiber Mats

These are generally manufactured by firing a mixture of amorphous silica, lime, feldspar, sodium silicate, boron silicate and/or other ingredients. This makes it possible to obtain wafers which are then re-melted and drawn by a winder system until yarns are obtained having a diameter of 10 μm which are chopped so as to have a length of 12 mm.

The continuous manufacture of the glass-fiber mat relies on a so-called “wet” process, quite similar to the papermaking techniques well known to those skilled in the art. A mix comprising about 5% glass fibers, water and various additives is deposited on a filtering forming table by means of a “water box”. After this preforming, the binder (a vinyl or acrylic resin or melamine) is deposited on the glass nonwoven. The web is then dried at about 140° C. in order to remove the residual water and to crosslink the binder. The manufacturing line terminates in devices for winding and cutting to various widths.

Various publications, especially patent applications in the name of Schuller, teach this technique.

The function of this mat is inter alia to limit the penetration of the plasterboard composition during manufacture of the boards. It is generally made hydrophobic and therefore fulfils a role similar to the peelable silicone sheet according to document DE-A-2 008 714.

This mat may furthermore receive an additional hydrophobic and/or water-repellent coating, using a technique described for example in U.S. Pat. No. 5,397,631 and U.S. Pat. No. 5,552,187. Thus, the mat according to the invention may receive a coating of the following types: (i) wax/asphalt emulsion; (ii) polysiloxane; (iii) dried latex containing a resin, especially poly(vinylidene-co-polymer); (iv) 15-35 wt % of solid resin, 20-65 wt % of a filler and up to 5 wt % of an additive chosen from pigments, thickeners, defoaming agents, dispersants, preservatives or a mixture thereof. The resulting coating may be such that no fiber of the mat projects therefrom (the surface of the coating being smooth) and/or such that the surface absorption measured using the modified Cobb test (described in Patent U.S. Pat. No. 5,397,631 in column 9, lines 15 to 48) is less than 2.4 g and preferably less than 0.5 g and/or is capable of forming a bond with Portland-based cement. This coating can be obtained in particular by the application of a latex and by drying.

Coating Composition

Mineral Filler

This may be chosen from the group consisting of mineral fillers which release water (structural water or water of crystallization), such as hydrated alumina, calcium carbonate, white kaolin, clays and mixtures thereof.

Advantageously, clays are used whose surface finish has been modified by waterproofing, for example by means of stearates or titanates.

It is preferred to use fine white fillers, that is to say those having a particle size of less than 40 μm, particularly less than 20 μm.

The preferred filler used is either a mixture of hydrated alumina and clay having a hydrated alumina/clay mass ratio of between 30/70 and 70/30, or a mixture of hydrated alumina and kaolin having a hydrated alumina/kaolin mass ratio of between 30/70 and 70/30 or pure alumina.

Binder

The binder may be organic or mineral.

As organic binder, it is possible to use a binder of the vinyl type such as an ethylene/vinyl acetate resin.

As binder, mention may also be made in general of ethylene/vinyl acetate copolymers (plasticized or unplasticized EVAs), ethylene/vinyl versatate and vinyl acetate/vinyl versatate copolymers, polyacrylics, vinyl acetate/acrylic copolymers, styrene/acrylic copolymers, vinyl acetate/vinyl versatate/acrylic terpolymers and blends thereof.

As mineral binder, it is possible to use a binder of the alkali metal silicate type, such as a sodium silicate or a potassium silicate. It is preferred to use a vinyl-type binder insensitive to re-wetting (which would in general result in wrinkles in the glass mat).

Water-repellent Agent

The water-repellent agent may be chosen from the group consisting of fluorocarbons and silicone oils.

According to a preferred embodiment of the invention, the coating composition comprises:

from 85 to 95% of a mineral filler which is either a mixture of hydrated alumina and clay having a hydrated alumina/clay mass ratio of between 30/70 and 70/30, or a mixture of hydrated alumina and kaolin having a hydrated alumina/kaolin mass ratio of between 30/70 and 70/30 or pure hydrated alumina;

from 1 to 10% of a vinyl binder, for example an ethylene/vinyl acetate copolymer (EVA);

from 0.1 to 1% of a fluorocarbon or a silicone oil; and

water or another solvent.

Particularly preferred are coating compositions prepared by diluting a mixture composed of:

90 to 98% of aluminium hydroxide;

1 to 9% of a vinyl resin, for example EVA; and

0.1 to 1% of a fluorocarbon or a silicone oil.

Coating Method According to an Embodiment of the Invention

According to an embodiment of the invention, a coating composition as defined above is applied to the glass-fiber mat.

The glass-fiber mat is coated on a suitable line by carrying out the operations of mixing a liquid slurry, depositing this slurry on the mat by a conventional coating method and drying at various temperatures according to the type of coating. This coating generally creates a dissymmetry in the mat, the treatment being carried out on part of the thickness, generally up to 30 to 70%, and in general about 50%, of the thickness of the mat.

The coating grammage is preferably between 200 and 300 g/m².

Again, various publications, especially patent applications in the name of Schuller, teach this technique.

It has been found that a coating (for example in an amount of 250 g/m²) with a filler (for example a white or very slightly coloured filler), whatever its nature, in combination with an organic binder (for example in an amount of 5%), makes it possible to significantly reduce the porosity and the permeability of the glass mat. This has the consequence of preventing any local penetration of plaster, while at the same time ensuring, because of the dissymmetry of the coated glass mat, that there is a homogeneous bond between the glass mat and the core of the plasterboard.

Process for Manufacturing Plasterboards According to the Invention

Finally, the third subject of the invention is a continuous process for manufacturing plasterboards, essentially comprising the following steps:

preparation of a plaster slurry by mixing the various constituents of the composition with water in a mixer;

deposition of the slurry thus prepared on at least one coated glass mat, on the uncoated side of this mat, followed by the shaping and the covering of the upper face of the slurry using a second reinforcing material, preferably a second coated glass mat;

where appropriate, shaping of the edges of the board obtained previously by moulding the fresh plaster on profiled bands, this shaping consisting especially in feathering the edges of the board;

hydraulic setting of the hydratable calcium sulphate on a manufacturing line while the ribbon of hydratable calcium sulphate board runs along a conveyor belt;

cutting of the ribbon at the end of the line into predetermined lengths; and

drying of the boards obtained.

The invention applies particularly well to plasterboards whose core composition and the manufacture of which are described in the aforementioned European Patent Application No. EP-A-0 470 914.

Preferred Plaster Composition

An embodiment of the invention applies particularly well to plasterboards whose core composition is the following:

from 55 to 92% of hydrated calcium sulphate;

from 0.1 to 5% of mineral and/or refractory fibers;

from 3 to 25% of a mineral additive;

from 1 to 5% of unexpanded vermiculite; and

from 3 to 15% of hydrated alumina.

According to a preferred embodiment of the invention, the nature and the amount of the mineral additive are chosen so that the plasterboard composition contains at most 2% crystalline silica and/or at most 1% cellular crystalline silica, that is to say having crystals of less than 5 microns in size. Such a composition then has the advantage of having a crystalline silica, especially cellular crystalline silica, content in accordance with the recommendations of the International Agency for Research on Cancer, in which it is recommended to reduce the use of cellular crystalline silica as much as possible as this compound is presumed to have a maximum toxicity.

The mineral and/or refractory fibers are preferably glass fibers. They may be short (3 to 6 mm on average) or else long (10 to 24 mm on average) or of intermediate lengths. Preferably, glass fibers having a single length of 13 mm±5 mm are used.

In particular, fibers coming from an E-type glass are used, these possibly being in two forms, one being in a form called “roving” comprising glass strands supplied on reels and cut before they are introduced into the usual circuit for mixing the hydratable calcium sulphate with water, or else in the form of precut strands which are metered before mixing the hydratable calcium sulphate with water.

Preferably, fibers having a length of about 13 mm (±5 mm) and a diameter of about 13 microns (±5 μm) are used.

The essential function of the glass fibers is to impart high-temperature mechanical strength, allowing the cohesion of the calcined plaster to be maintained.

As mineral additive, numerous clays may be used. The advantages afforded by clays are, on the one hand, the fact that they release the water that they contain (water of constitution) when they are heated to a temperature between 100 and 600° C. and, on the other hand, the fact that they compensate for the shrinkage of the plaster in a fire because of their ability to exfoliate.

Preferably, the nature and the amount of mineral additive are chosen so that the plaster composition contains at most 2% crystalline silica and/or at most 1% cellular crystalline silica.

It is therefore advantageous to use a mineral additive comprising at most 7.5% of cellular crystalline silica.

As mineral additive, it is possible to use a mineral additive comprising essentially a clayey material, the amount of crystalline silica of which is at most equal to about 15% by weight of the mineral additive, and an inert mineral supplement compatible with the clayey material and dispersible in the hardened plaster substrate.

For example, it is possible to use a mineral additive comprising, as clayey material, kaolin, illite or quartz and, as mineral supplement, dolomite. In particular, a mineral additive is used which has the following composition (in percentages by weight with respect to the total weight of mineral additive):

25% of kaolin;

10% of illite;

15% of quartz; and

50% of dolomite.

The calcined chemical composition of this additive is the following (in %):

SiO₂:43

TiO₂:1.1

Al₂O₃:15

Fe₂O₃:1.6

K₂O:1.2

CaO:23

MgO:14.

Its particle size is expressed by a 63 μm sieve retention of less than 15%.

Its loss on ignition at 900° C. is 26.5%.

The preferred plaster composition according to an embodiment of the invention comprises unexpanded vermiculite, which is an aluminium-iron-magnesium silicate in the form of flakes which expand at a temperature above 200° C., thereby making it possible to compensate for the shrinkage of the plaster. Furthermore, the unexpanded vermiculite improves the thermal resistance of the plaster.

Preferably, a micronized unexpanded vermiculite is used, that is to say one in which all the particles are less than 1 mm in size. This has the advantage of making it possible for the vermiculite to be better distributed within the plaster and of avoiding an abrupt expansion causing structural disorders.

Hydrated alumina (aluminium trihydroxide) is preferably used with a fine particle size (median diameter of about 10 microns). It has the effect of giving rise to an endothermic reaction complementary to that of gypsum, especially by having a water of crystallization content of about 35%, the water being releasable between 200 and 400° C. (gypsum containing about 20% of water releasable at about 140° C.).

The preferred plaster composition according to an embodiment of the invention may furthermore possibly include up to 4%, especially from 1 to 4%, of boric acid, as this product advantageously loses its water of constitution above 100° C., thereby contributing to the fire resistance of the plasterboard. Moreover, boric acid modifies the crystalline structure of the hydrated calcium sulphate in a manner favourable as regards shrinkage on ignition.

The composition according to an embodiment of the invention may be prepared by mixing, per 100 parts by weight of composition:

from 55 to 92 parts by weight of hydratable calcium sulphate;

from 0.1 to 5 parts by weight of mineral and/or refractory fibers;

from 3 to 25 parts by weight of a mineral additive;

from 1 to 5 parts by weight of unexpanded vermiculite; and

from 3 to 15 parts by weight of hydrated alumina.

The preferred composition according to an embodiment of the invention has the following advantages:

the composition can be easily formulated in the form of a fluid slurry which is then converted, advantageously continuously, into a plasterboard in conventional plants used for this type of manufacture;

it provides effective fire protection; thus boards according to the invention, having a thickness of around 12.5 mm and a density of around 0.88 g/cm³, guarantee fire resistance for longer than 2 hours;

by virtue of their good dimensional stability, the boards according to the invention after the fire resistance test maintain a good overall appearance without any deep cracking and exhibit mechanical integrity (this behaviour is important for applications requiring a very high level of fire protection, such as air ducts for ventilation and for smoke venting, in which there is a requirement for them to seal against hot gases under high pressure);

the results of the reaction-to-fire tests on plasterboards according to the invention are very good: when these boards are exposed to the action of a radiating source and/or a specific burner under defined conditions (for 20 minutes), capable of igniting the gases released and of propagating the combustion, it has been found that there is no ignition and deterioration of these boards is merely superficial; after this test, the plasterboards according to the invention are therefore still capable of stopping the spread of a fire;

because of its lightness and its ability to be worked (cut, nailed, screwed, stapled, screwed/bonded, etc.), it is very easy to install; advantageously, it has feathered edges with which it is possible to produce reliable joints between the boards using plasterboard jointing compounds, for example of the type of those used for plasterboards faced with paperboard, and preferably fire-resistant jointing compounds; in addition, there are various possible ways of finishing off the construction elements produced with boards according to the invention, especially with paint, wallpaper, etc.;

it has the application characteristics required in the construction field: such as flexural stiffness, high impact strength, moisture resistance and no creep in the presence of moisture or under its own weight when it is mounted as a ceiling; and

finally, given that it can be manufactured using a simple process well known in the plasterboard field and that, in addition, the raw materials of which it is composed are quite inexpensive, the plasterboard according to the invention has the advantage of having a moderate manufacturing cost.

Good performance is achieved with the following composition:

70 to 80% of a hydratable calcium sulphate semi-hydrate;

1% of glass fibers;

10 to 15% of the clay described above, consisting of 25% kaolin, 10% illite, 15% quartz and 50% dolomite;

2 to 4% of unexpanded micronized vermiculite;

6 to 10% of hydrated alumina; and

0 to 2% boric acid.

Of course, provided that the proportions assigned to each of the essential constituents are respected, it is possible to introduce, into the composition according to the invention, by way of secondary ingredients, additives normally used to facilitate the processing of the other constituents or for imparting additional particular properties on the composition. By way of examples of such additives, mention may be made of thinners, foaming agents, setting accelerators and water-repellent agents.

Aeraulic Duct

The invention makes it possible to obtain improved aeraulic ducts, namely smoke-venting ducts (for a fire internal to the element) and ventilation ducts (for a fire external to the element). The mat forming the facing will be that side exposed to the fire. The fire-wall classification is in general one hour in both cases.

This system is based on a duct body made as four faces precut in the workshop and assembled, especially by stapling in a connecting sleeve which is itself also prepared in the workshop. By way of non-limiting example, mention may be made of a single-faced (one mat face) smoke-venting or ventilation duct in a frame comprising a structure made of steel sections from which the duct is suspended. The internal cross section of the duct portions is 600×400 mm, its length being variable, for example 1000 mm. The body of the duct portion is produced from 25 mm thick boards according to the invention, joined together as a single thickness. The portions are connected by sleeves made of the board according to the invention, the boards being precut and joined together, having a length of 200 mm and an internal cross section of 650×450 mm, fitting around the portions of the duct. If necessary, a plaster may be used to make a perfect seal.

### EXAMPLES

The following examples are given purely by way of illustration and are in no way limiting in character.

The hydrated alumina used in the examples is alumina trihydrate Al(OH)₃, the characteristics of the dry hydrate of which are as follows:

whiteness: 92%;

moisture content: 0.2%;

bulk density: 0.8 g/cm³;

particle size: d₅₀=10 μm;

45 μm screen oversize: less than 1%;

Al₂O₃ weight content: 65%;

H₂O weight content: 35%.

With regard to the fire performance of the plasterboards, a distinction is made between:

a) the reaction to fire, which involves the behaviour of the materials subjected to a localized fire. In the case of a plasterboard, the facing is the predominant element for the classification;

b) the fire resistance, which relates to the behaviour of the work exposed to a fully developed fire (post-flashover situation). The core and the facing of the plasterboards contribute to the performance of the work. The contribution by the facings to the fire resistance performance of the plasterboard is limited by the melting or destruction of the glass-fiber mat. This applies both to the external facing directly exposed to the fire and to the facing at the back of the board, which contributes to the hot mechanical strength.

### Example 1

According to the aforementioned European Patent Application No. EP-A-0 470 914, the following composition was prepared:

76% hydratable calcium sulphate (obtained from the industrial baking of desulphurized gypsum (FGD));

1% of glass fibers;

10% of hydrated alumina;

9% of quartz; and

4% of talc.

Using this composition, plasterboards were obtained with the following facings:

board A (according to the prior art): 0.5 mm thick glass mat reinforced with a glass mesh having 3/1 mesh cells coated with an organic (vinyl or acrylic) composition, the total (mat+mesh+organic coating) grammage being 140 g/m²;

board B (according to the prior art): 0.85 mm thick uncoated glass mat, with a total grammage of 110 g/m²;

board C (according to the invention): 0.95 mm thick glass mat coated with a coating composition comprising hydrated alumina (about 94.5%), an acrylic resin (about 5%) and a fluorocarbon (about 0.3%), the composition being applied in an amount of 250 g/m².

### Example 2

Certain properties of boards A to C were measured. The results obtained are given in the following table:

| | BOARDS | | |
|---|---|---|---|
| PROPERTIES | A | B | C (invention) |
| Porosity to air (l/m² · s) | 550 | 1600 | 200 |
| Permeability to the plaster | <1200 | <700 | <300 |
| slurry (g) | | | |
| Tensile strength: | | | |
| SL (N/50 mm) | >730 | 550 | 650 |
| SN (N/50 mm) | >350 | 330 | 500 |
| Loss on ignition at 650° C. | 50 | 21 | 31 |
| (%) | | | |
| Gross calorific value (GCV): | | | |
| per unit mass (MJ/kg) | 12 | 4 | 2 |
| per unit area (MJ/m²) | 1.7 | 0.5 | 0.65 |
| Behaviour at very high | Melts at 700° C. | Melts at 800° C. | Softens at |
| temperature | | | 900° C., |
| | | | crumbles to a |
| | | | powder at 1000° C. |

The current standards require, for a classification called “Euroclassification”, that the GCV per kilogram or the GCV per square meter be less than or equal to 2 MJ.

It may be seen that only board C has both a GCV per kilogram and a GCV per square meter less than or equal to 2 MJ.

### Example 3

Based on the composition prepared in Example 1, board D according to the prior art and boards E to K according to the invention were prepared, the characteristics of these boards being given in the following table:

| | BOARDS | | | | | | | |
|---|---|---|---|---|---|---|---|---|
| | D | E | F | G | H | I | J | K |
| Coating: | — | | | | | | | |
| alumina (%) | | 95 | 95 | 95 | 94.9 | 94.8 | 94.7 | 94.8 |
| EVA resin (%) | | 5 | 5 | 5 | 5 | 5 | 5 | 5 |
| fluorocarbon (%) | | — | | | 0.1 | 0.2 | 0.3 | 0.2 |
| water * (%) | | 90 | 90 | 90 | 90 | 90 | 90 | 60 to |
| | | | | | | | | 80 |
| Total grammage | 103.9 | 256.9 | 311.5 | 311.0 | 366.0 | 370 | 363 | 338 |
| (g/m²) | | | | | | | | |
| Facing thickness | 0.795 | 0.90 | 0.94 | 0.94 | 0.87 | 0.87 | 0.92 | 0.94 |
| (mm) | | | | | | | | |

* This is the % of water in the mixture of solid matter (alumina/resin/optional water-repellent agent) and water.

### Example 4

Certain properties of boards D to K were measured. The results obtained are given in the following table:

| | BOARDS | | | | | | | |
|---|---|---|---|---|---|---|---|---|
| | D | E | F | G | H | I | J | K |
| Water-drop absorption (in | — | — | — | | | | | — |
| seconds): | | | | | | | | |
| mat | | | | 18 | 130 | >1000 | >1000 | |
| board | | | | 10 | 105 | | | |
| 85° gloss* (2 paint passes) | 0.7 | 1.00 | 1.6 | 3.2 | 2.0 | 2.4 | 4.6 | — |
| GCV: | | | | | — | — | — | |
| per unit mass (MJ/kg) | 4.05 | 2.95 | 2.90 | 2.0 | | | | 2.0 |
| per unit area (MJ/m²) | 0.421 | 0.756 | 0.903 | 0.622 | | | | 0.676 |
| Loss on ignition (%): | | | | | | | | |
| at 650° C. | 21.3 | 30.2 | 30.7 | 31.5 | | | | 31.5 |
| at 1000° C. | 22.1 | | | 32.9 | | | | |
| Loss on ignition at 650° C. | 21.3 | 11.6 | 10.3 | 9.9 | | | | |
| (organic estimate): | | | | | | | | |
| Observations after loss on | | | | | | | | |
| ignition: | | | | | | | | |
| at 700° C. | NTR | | | NTR | | | | NTR |
| at 800° C. | Melting | | | Crumpling | | | | Crumpling |
| | starts | | | | | | | |
| at 900° C. | Shrinking | | | Crumpling | | | | Crumpling |
| | and melting | | | and | | | | and |
| | | | | softening | | | | softening |
| at 1000° C. | Vitrification | | | Crumbling | | | | Crumbling |
| | | | | to a | | | | to a |
| | | | | powder | | | | powder |

*Gloss using a light beam inclined at 85°

It may therefore be seen that the protection provided by the coating raises the temperature at which the glass-fiber mat melts and delays its destruction. Thus (cf. boards G and K, for example), a coating based on hydrated alumina allows the softening of the glass mat to be delayed until 900° C.

During these fire-resistance tests on a work, delamination of the glass mat coated with hydrated alumina was thus observed after 50 minutes, which corresponds to a standardized temperature of 920° C. of the oven.

Moreover, incorporating the water-repellent agent has the effect of increasing the water-drop absorption times (see boards H, I and J).

### Example 5

Based on the composition prepared in Example 1, boards L to Q were prepared, the characteristics of which are given in the following table:

| | BOARDS | | | | | |
|---|---|---|---|---|---|---|
| | L | M | N | O | P | Q |
| Coating: | | | | | | |
| alumina (%) | 95 | 94.5 | 94 | 47.5 | | 47.5 |
| limestone (%) | | | | 47 | | |
| clay (%) | | | | | 94.5 | 47 |
| EVA (%) | 5 | 5 | 5 | 5 | 5 | 5 |
| silicone (%) | | 0.5 | 1.0 | 0.5 | 0.5 | 0.5 |
| water* (%) | 90 | 90 | 90 | 90 | 90 | 90 |
| Total grammage (g/m²) | 350 | 350 | 350 | 350 | 350 | 350 |

*This is the % of water in the mixture of solid matter (alumina/resin/optional water-repellent agent) and water.

### Example 6

Certain properties of boards L to Q were measured. The results obtained are given in the following table:

| | BOARDS | | | | | |
|---|---|---|---|---|---|---|
| | L | M | N | O | P | Q |
| Water-drop absorption (in seconds): | | | | | | |
| mat | 20 | 50 | 70 | 100 | 360 | 240 |
| board | 1 | 33 | 44 | 45 | 20 | 20 |
| 85° gloss* (2 paint passes) | 2.7 | 2.00 | 1.2 | 2.0 | 4.8 | 4.0 |
| GCV: | | | | | | |
| per unit mass (MJ/kg) | | | | | 1.65 | |
| per unit area (MJ/m²) | | | | | 0.495 | |
| Loss on ignition (%): | | | | | | |
| at 650° C. | | | | | | |
| at 1000° C. | | 32.9 | | 36.4 | 27.2 | 31.5 |
| Observations after loss on ignition: | | | | | | |
| at 700° C. | | | | | | |
| at 800° C. | | | | | | |
| at 900° C. | | | | | | |
| at 1000° C. | | Not vitrified, | | Not vitrified, | Not vitrified, | Not vitrified, |
| | | very powdery | | very powdery | good cohesion | good cohesion |

*Gloss using a light beam inclined at 85°

Again it may be seen that incorporating the water-repellent agent increases the water-drop absorption times (see boards M to Q compared with board L).

### Example 7

Based on the composition prepared in Example 1, boards R to W were prepared, the characteristics of which are given in the following table:

| | BOARDS | | | | | |
|---|---|---|---|---|---|---|
| | R | S | T | U | V | W |
| Coating: | | | | | | |
| alumina (%) | 47.5 | 47.5 | | | | |
| limestone (%) | | | | | | 94.5 |
| kaolin | 47 | 47 | 94 | 94 | 94 | |
| clay (%) | | | | | | |
| EVA (%) | 5 | 5 | 5 | 5 | 5 | 5 |
| silicone (%) | 0.5 | 0.5 | 1.0 | 1.0 | 0.5 | 0.5 |
| Total grammage (g/m²) | 350 | 350 | 350 | 500 | 350 | 350 |

### Example 8

Certain properties of boards R to W were measured. the results obtained are given in the following table:

| | BOARDS | | | | | |
|---|---|---|---|---|---|---|
| | R | S | T | U | V | W |
| Water-drop absorption (in | | | | | | |
| seconds): | | | | | | |
| mat | 60 | 75 | 95 | 155 | 150 | 540 |
| board | 20 | 40 | 35 | 55 | 25 | 340 |
| 85° gloss* (2 paint passes) | 2.3 | 2.5 | 3.2 | 11.5 | 2.7 | 2.1 |
| GCV: | | | | | | |
| per unit mass (MJ/kg) | 1.65 | | 1.65 | | | |
| per unit area (MJ/m²) | 0.79 | | 0.74 | | | |
| Loss on ignition (%): | | | | | | |
| at 650° C. | | | | | | |
| at 1000° C. | 25.6 | 23.8 | 17.5 | 17.2 | 16.9 | 36.9 |
| Observations after loss on ignition: | | | | | | |
| at 700° C. | | | | | | |
| at 800° C. | | | | | | |
| at 900° C. | | | | | | |
| at 1000° C. | Not vitrified, | Not vitrified, | Not vitrified, | Not vitrified, | Not vitrified, | Crumbling to a |
| | good | good | good | good | good | powder |
| | cohesion | cohesion | cohesion | cohesion | cohesion | |

*Gloss using a light beam inclined at 85°

### Example 9

Based on the composition prepared in Example 1, boards X, Y, Z, AA, BB, CC, DD and EE were prepared, the characteristics of which are given in the following table:

| | BOARDS | | | | | | | |
|---|---|---|---|---|---|---|---|---|
| | X | Y | Z | AA | BB | CC | DD | EE |
| Coating: | | | | | | | | |
| alumina | | | | | | | 47.5 | |
| (%) | | | | | | | | |
| limestone | | | | | | | | 47.5 |
| (%) | | | | | | | | |
| clay⁽¹⁾ | 95 | 94.5 | | | | | | |
| (%) | | | | | | | | |
| clay⁽²⁾ | | | 94 | 97 | 90 | 89.5 | 47 | 47 |
| (%) | | | | | | | | |
| EVA (%) | 5 | 5 | 5 | 2.5 | | | | |
| sodium | | | | | 10 | 10 | 5 | 5 |
| silicate | | | | | | | | |
| (%) | | | | | | | | |
| silicone | | 0.5 | 1.0 | 0.5 | | 0.5 | 0.5 | 0.5 |
| (%) | | | | | | | | |
| Theoretical | 350 | 350 | 350 | 500 | 350 | 350 | 350 | 350 |
| total | | | | | | | | |
| grammage | | | | | | | | |
| (g/m²) | | | | | | | | |

⁽¹⁾Clay rendered hydrophobic by a stearate
⁽²⁾Clay rendered hydrophobic by a titanate

### Example 10

Certain properties of boards X to EE were measured. The results obtained are given in the following table:

| | BOARDS | | | | | | | |
|---|---|---|---|---|---|---|---|---|
| | X | Y | Z | AA | BB | CC | DD | EE |
| Water-drop absorption (in | | | | | | | | |
| seconds): | | | | | | | | |
| mat | 360 | 420 | 20 | 13 | 5 | 480 | 390 | 180 |
| board | 120 | 420 | 95 | 75 | 10 | 120 | 35 | 180 |
| 85° gloss* (2 paint passes) | 10.8 | 18.8 | 2.8 | 6.2 | 4.5 | 2.1 | 11.2 | 7.6 |
| GCV: | | | | | | | | |
| per unit mass | | 3.15 | 2.10 | 2.95 | 1.45 | 2.70 | 2.50 | 3.15 |
| (MJ/kg) | | | | | | | | |
| per unit area | | 1.10 | 0.67 | 0.80 | 0.73 | 1.13 | 0.90 | 0.98 |
| (MJ/m²) | | | | | | | | |
| Loss on ignition (%): | | | | | | | | |
| at 700° C. | | | 12.8 | 13.3 | 8.8 | 10.0 | 20.6 | 19.0 |
| at 1000° C. | 12.7 | 13.9 | 13.9 | 14.1 | 9.1 | 11.4 | 21.7 | 26.3 |

*Gloss using a light beam inclined at 85°

| | BOARDS | | | | | | | |
|---|---|---|---|---|---|---|---|---|
| | X | Y | Z | AA | BB | CC | DD | EE |
| Observations | | | | | | | | |
| after loss on | | | | | | | | |
| ignition: | | | | | | | | |
| at 700° C. | | | NTR | NTR | Greenish | Greenish | NTR | NTR |
| | | | | | (uncoated | (uncoated | | |
| | | | | | side) | side) | | |
| at 800° C. | | | NTR | Slight softening | Slightly pinkish | Slightly | Lift-up | Lift-up |
| | | | | | | pinkish | | |
| at 900° C. | | | Pinkish, slight | Pinkish, slight | Slightly pinkish | Slightly | Lift-up | Slight |
| | | | softening | lift-up | | pinkish | | crusting |
| | | | | | | | | (uncoated |
| | | | | | | | | side) |
| at 1000° C. | Not vitrified, | Not vitrified, | | Lift-up, good | Lift-up, | Lift-up, | Lift-up, | Very |
| | good cohesion | quite good | | cohesion | good cohesion | good | pinkish, good | powdery |
| | | cohesion | | | | cohesion | cohesion | |

*NTR: Nothing to report

### Example 11

The painting behaviour of 4 groups of two identical boards joined together by a jointing compound, sold under the name PREGYLYS 45 by the Applicant, was measured.

The boards of group 1 were plasterboards having the composition given in Example 1, having a glass mat coated with a PREGYLYS 45 coating composition.

The boards of group 2 were plasterboards having the composition given in Example 1, having a glass mat coated with alumina.

The boards of group 3 were plasterboards having the composition given in Example 1, having an uncoated glass mat.

The boards of group 4 were plasterboards of the prior art, having a glass mat reinforced with a glass mesh and without a mineral coating.

The colour of the boards and of the joints before applying paint and after applying two coats of a white satin acrylic paint was observed.

The results are given in the following table:

| | Board group | | | |
|---|---|---|---|---|
| | 1 | 2 | 3 | 4 |
| Before | White colour | Uniform white | White colour | White colour |
| applying paint | with slight | colour | with a few | with a few |
| | hues in places | | stains on the mat | stains on the mat |
| After applying | The joint is not | The joint is not | The joint is | The joint is |
| paint | visible in | visible in | visible in | slightly visible |
| | perpendi-cular | perpendi-cular | perpendi-cular | in perpendi- |
| | light | light | light | cular light |
| | The joint is | The joint is | Difference in | Difference in |
| | visible in | visible in | rough-ness | rough-ness |
| | oblique light | oblique light | Joint gloss: | Joint gloss: |
| | No roughness | No roughness | 14.4 | 12.4 |
| | difference | difference | Board gloss: | Board gloss: |
| | Joint gloss: | Joint gloss: | 2.6 | 4.3 |
| | 12.9 Board | 12.7 Board | | |
| | gloss: 7.7 | gloss: 6.5 | | |

It may be seen that the gloss goes from 2.6 in the case of the control boards without a coating (boards of group 3) to 6.5 (boards of group 2).

Although only preferred embodiments are specifically illustrated and described herein, it will be appreciated that many modifications and variations of the present invention are possible in light of the above teachings and within the purview of the appended claims without departing from the spirit and intended scope of the invention.

What is claimed is:

1. A plasterboard having a plaster-based core, wherein the plasterboard is provided on at least one of its sides with a glass-fiber mat facing, the mat facing being coated on an external face with a coating composition comprising:
a mineral filler, with the exception of hydratable calcium sulphates; and
an organic or mineral binder.

2. The plasterboard according to claim 1, wherein the mineral filler is chosen from the group consisting of hydrated alumina, calcium carbonate, white kaolin, clays and mixtures thereof.

3. The plasterboard according to claim 1, wherein the clay is rendered hydrophobic.

4. The plasterboard according to claim 1, wherein the mineral filler is hydrated alumina.

5. The plasterboard according to claim 1, wherein the mineral filler is a mixture of hydrated alumina and clay having a hydrated alumina/clay mass ratio of between 30/70 and 70/30.

6. The plasterboard according to claim 1, wherein the mineral filler is a mixture of hydrated alumina and kaolin having a hydrated alumina/kaolin mass ratio of between 30/70 and 70/30.

7. The plasterboard according to claim 1, wherein the organic binder is of the vinyl type.

8. The plasterboard according to claim 1, wherein the organic binder is an ethylene/vinyl acetate resin (EVA).

9. The plasterboard according to claim 1, wherein the mineral binder is of the sodium silicate type.

10. The plasterboard according to claim 1, wherein the coating composition further includes a water-repellent agent.

11. The plasterboard according to claim 10, wherein the water-repellent agent is chosen from the group consisting of fluorocarbons and silicone oils.

12. The plasterboard according to claim 1, wherein the glass-fiber mat has been coated with a coating composition prepared by diluting a mixture composed of:
90 to 98% of hydrated alumina;
1 to 9% of a vinyl resin; and
0.1 to 1% of a fluorocarbon or a silicone oil.

13. The plasterboard according to claim 1, wherein the coating composition penetrates up to 30 to 70% of the thickness of the glass-fiber mat.

14. The plasterboard according to claim 12, wherein the coating composition penetrates up to 30 to 70% of the thickness of the glass-fiber mat.

15. The plasterboard according to claim 1, wherein the coating has a grammage of between 200 and 300 g/m².

16. The plasterboard according to claim 12, wherein the coating has a grammage of between 200 and 300 g/m².

17. The plasterboard according to claim 1, wherein the plasterboard has an improved fire resistance.

18. The plasterboard according to claim 1, further having a hydrophobic or water-repellent coating on at least one side of the glass-fiber mat.

19. The plasterboard according to claim 12, further having a hydrophobic or water-repellent coating on at least one side of the glass-fiber mat.

20. The plasterboard according to claim 18, wherein the coating is such that no fiber of the glass-fiber mat projects therefrom, the surface of the coating being smooth or is such that the surface absorption measured using the modified Cobb test is less than 2.4 g or is capable of forming a bond with Portland-based cement.

21. The plasterboard according to claim 18, wherein the coating is such that no fiber of the glass-fiber mat projects therefrom, the surface of the coating being smooth or is such that the surface absorption measured using the modified Cobb test is less than 0.5 g or is capable of forming a bond with Portland-based cement.

22. The plasterboard according to claim 19, wherein the coating is such that no fiber of the mat projects therefrom, the surface of the coating being smooth or is such that the surface absorption measured using the modified Cobb test is less than 2.4 g or is capable of forming a bond with Portland-based cement.

23. The plasterboard according to claim 19, wherein the coating is such that no fiber of the mat projects therefrom, the surface of the coating being smooth or is such that the surface absorption measured using the modified Cobb test is less than 0.5 g or is capable of forming a bond with Portland-based cement.

24. A glass-fiber mat coated with a coating composition, the coating composition comprising:
a mineral filler, with the exception of hydratable calcium sulphates;
an organic or mineral binder; and
a water-repellent agent.

25. The glass-fiber mat according to claim 24, wherein the coating composition is prepared by diluting a mixture composed of:
90 to 98% of hydrated alumina;
1 to 9% of a vinyl resin, preferably EVA; and
0.1 to 1% of a fluorocarbon or a silicone oil.

26. The glass-fiber mat according to claim 25, wherein the coating composition penetrates up to 30 to 70% of the thickness of the glass-fiber mat.

27. A process for manufacturing a plasterboard according to claim 1, comprising the following steps:
preparing a plaster slurry by mixing the various constituents of the composition with water in a mixer;
depositing the slurry on at least one coated glass-fiber mat, on the uncoated side of the mat, followed by the shaping and the covering of an upper face of the slurry using a second reinforcing material,
shaping the edges of the slurry by profiled bands;
hydraulic setting of the plaster slurry on a manufacturing line while the plaster slurry runs along a conveyor belt;
cutting the set plaster slurry and mat at the end of the line into predetermined lengths; and
drying the boards obtained.

28. The process of claim 27, wherein the second reinforcing material is a second coated glass fiber mat.

29. The process of claim 28, wherein the plaster slurry includes hydratable calcium sulphate.

30. An aeraulic duct comprising a plasterboard according to claim 1.

31. The aeraulic duct according to claim 30, wherein the duct is a smoke-venting duct or a ventilation duct.

32. The plasterboard according to claim 12, wherein the vinyl resin is EVA.

33. The plasterboard according to claim 18, wherein the coating is such that no fiber of the glass-fiber mat projects therefrom, the surface of the coating being smooth and is such that the surface absorption measured using the modified Cobb test is less than 2.4 g and is capable of forming a bond with Portland-based cement.

34. The plasterboard according to claim 18, wherein the coating is such that no fiber of the glass-fiber mat projects therefrom, the surface of the coating being smooth and is such that the surface absorption measured using the modified Cobb test is less than 0.5 g and is capable of forming a bond with Portland-based cement.

35. The plasterboard according to claim 19, wherein the coating is such that no fiber of the mat projects therefrom, the surface of the coating being smooth or is such that the surface absorption measured using the modified Cobb test is less than 2.4 g or is capable of forming a bond with Portland-based cement.

36. The plasterboard according to claim 19, wherein the coating is such that no fiber of the mat projects therefrom, the surface of the coating being smooth or is such that the surface absorption measured using the modified Cobb test is less than 0.5 g or is capable of forming a bond with Portland-based cement.
